(19) United States
(12) Patent Application Publication
(10) Pub. No.: US 2014/0054340 A1
(43) Pub. Date: Feb. 27, 2014

(54) REMOVABLE GLASS RACK FOR PICKUP TRUCK

(71) Applicants: Alex McDonald, Houston, TX (US); Lee Davis Weinstein, Arlington, MA (US)

(72) Inventors: Alex McDonald, Houston, TX (US); Lee Davis Weinstein, Arlington, MA (US)

(21) Appl. No.: 12/853,758

(22) Filed: Aug. 10, 2010

(51) Int. Cl. B60R 9/06

(52) U.S. Cl. CPC B60R 9/06
USPC 224/405

(57) ABSTRACT

A removable glass rack suitable for attachment to a variety of pickup trucks is disclosed. Rigidity in the un-attached state, combined with automatic alignment features and scratch prevention features make the rack particularly well suited for repeated rapid installation and removal, giving glass shop owners the option of quickly converting their glass trucks back to pickup trucks for non-business-hours use.

### FIELD OF THE INVENTION

The field of the invention relates to pickup trucks, transport systems for sheet materials, glass racks, and more specifically to glass racks mountable on pickup trucks.

### BACKGROUND OF THE INVENTION

For as long as glass windows have been commercially available, various methods and apparatus have evolved for transporting sheets of glass from manufacturer to distributor, and from distributor to consumer. Modern consumers of sheet glass are mainly businesses, since most glass which gets installed in residences is already pre-installed in window frames, mirror frames, and the like, whereas windows and mirrors installed in businesses are often large sheets of glass which are delivered un-framed. Modern consumers of curved glass (such as automobile windshields and automobile door windows) are also typically businesses.

There are two classes of modern glass delivery trucks: large, heavy-duty large-capacity glass trucks which are used for delivering glass from manufacturers to distributors (or to large construction sites during initial construction), and small, lighter-duty trucks that are used for delivering glass from distributors to small construction sites or repair job sites.

Large glass delivery trucks, such as shown in FIG. 1, typically consist of a truck cab-chassis (including engine, transmission, frame, wheels, etc.) manufactured by a vehicle company such as International, with a custom-built body (including glass racks) permanently installed on the frame by a glass truck manufacturer such as Unruh Fab Inc. These trucks are typically purchased by glass manufacturers or wholesalers, and are used to make deliveries to wholesalers, distributors, or the construction site of an office building, hotel or the like.

Glass shops typically use smaller glass-carrying trucks such as those shown in FIGS. 2 and 3. These trucks are typically standard pickup trucks which have been made into glass delivery vehicles by bolting a glass rack to the pickup bed and/or bed wall rails and other attachment points. To attach the glass-carrying rack, holes are typically drilled in the truck body to accommodate bolts to attach the glass-carrying rack. Sometimes the pickup truck modification is done by end users (for instance glass shop owner/operators), and sometimes the pickup truck modification is done by a glass truck manufacturer or an approved installer.

Attaching a glass rack to a pickup truck is typically an involved process that is done in a way that the rack is not intended to be removed. One disadvantage of permanent rack attachment is that it leaves the small business owner (glass shop owner) with a less broadly useful vehicle. The same disadvantage stated another way is that typically a small glass shop owner has to purchase an extra vehicle to serve as a glass truck, because a truck with a glass rack on it is not suitable as a recreational vehicle during non-business hours. There is a need for a glass rack suitable for attachment and detachment from a pickup truck, so that owners of small glass shops can more economically operate their businesses.

Another disadvantage of currently available pickup-truck-mountable glass racks is that they tend to be mounted in ways that require permanently altering the pickup truck in a way that may compromise resale value that can be recovered from the truck after it has lived out its useful life as a glass delivery vehicle. There is a need for a pickup-truck-mountable glass rack that requires no alteration or minimal alteration of the pickup on which it is installed, so as to maximize the resale value of the truck after is has served out its useful life as a glass delivery vehicle.

Currently available pickup-truck-mountable racks bolt in place in ways that require substantial time to attach the rack to the pickup truck body, and require permanent modification of the truck body to attach. While this results in a good theft deterrent for the rack itself, it also deters owners from transforming their glass trucks back into pickup trucks for non-glass-delivery applications. There is a need for a pickup-truck-mounted glass rack that can be attached and detached quickly (for instance, in a few minutes), with a means of attachment that still provides a good theft deterrent for the glass rack.

The weight and poor aerodynamics of today's pickup-truck-mounted glass racks results in poorer gas mileage and noisier driving conditions when the rack is mounted on the truck. In addition, glass racks typically add substantially to the width of a pickup truck, so a truck with a glass rack mounted on it typically can't park in a single parking space in a typical parking lot. Thus, a pickup truck with a typical glass rack on it becomes a more expensive and less desirable vehicle to use for non-glass-delivery applications. There is a need for a pickup-mountable glass rack which can be installed and removed quickly and easily, allowing increased efficiency and better aerodynamic performance for non-glass-carrying uses of the truck.

Another reason that today's pickup-truck mounted glass racks are not suitable for repeated installation and removal is that they are made in such a way that they are not rigid until they are attached to the truck body, so they are difficult and unwieldy to move and store. In addition, they are made in such a way that the likelihood of repeatedly incrementally damaging the finish or the pickup truck bed walls and/or sides during installation and removal is significant. There is a need for a removable pickup-truck-mountable glass rack with innovative features that significantly reduce the potential for damage to the truck during removal and re-installation of the rack. There is a need for a pickup-truck-mountable removable glass rack that is easy to store.

When a glass rack is fully loaded, it may have a weight on the order of the rated carrying capacity for the pickup truck it is mounted on. In recent years, pickup truck manufacturers have used lighter-gauge steel in some panels when manufacturing pickup trucks, to reduce manufacturing cost and weight. While reducing the weight and strength of steel used in pickup trucks, manufacturers attempt to keep enough strength in the pickup truck bed that when carrying a normal load (where the load weight is typically supported primarily by the pickup bed), if the truck goes over a bump, the pickup bed is strong enough not to become deformed by the load.

Unfortunately, pickup truck-mounted glass racks often transfer most of their load to the pickup truck bed rails (the top of the bed walls), rather than the bed itself. Thus, many of today's pickup-truck-mounted glass racks can cause permanent deformation of the bed walls if a pickup with a fully loaded glass rack goes over a bump in transit. Some manufacturers of glass racks for pickup trucks have made available optional bracing supports that bolt in place inside the pickup truck bed walls, and transfer rack load vertically to the truck bed to lessen the compressive force on the bed walls. These vertical braces (such as shown in FIG. 4) are typically mounted by drilling holes through the steel of the bed or bed wall, and bolting the brace in place. Such modifications are time consuming, and may make the pickup unsuitable for non-glass-carrying uses. Such modifications may also render the pickup truck less saleable after its life as a glass-carrying truck There is a need for innovative bracing systems that can be installed and/or uninstalled quickly and do not permanently mechanically alter the pickup truck in which they are installed.

### SUMMARY OF THE INVENTION

It is an object of the present invention to provide glass racks suitable for repeated rapid installation on and removal from a pickup truck. It is a further object of the present invention to provide a pickup-truck-mountable glass rack that can be installed and removed with minimal labor and a minimal number of people. It is a further object of the present invention to provide a removable pickup-truck-mountable glass rack with theft-deterrent features. It is a further object of the present invention to provide a removable, pickup-truck-mountable glass rack with innovative features which substantially reduce the likelihood of damage to the body and bed finish of a pickup truck during the installation and removal process.

In one aspect, the present invention provides a glass rack with improved torsional stability while off-truck, due to the addition of a midline torsional brace 901 which (when the rack is mounted on a pickup truck) is attached just above bed-wall height just behind the cab of the pickup truck to which the rack mounts. In a preferred embodiment where the rack can be adjusted to fit various widths of pickup beds, this member may be composed of two members with a slidable overlap region. In a preferred embodiment, midline torsional brace 901 attached at multiple points 902 and 903 on each side of the rack to provide extra torsional rigidity. In an alternate embodiment, midline torsional brace 901 may be made as a pair of diagonal cables or bars affixed line an “x” to vertical braces at the front of the rack. In an alternate embodiment, an additional midline removable torsional brace may be included for attachment to the rear of the rack when during installation and removal of the rack, or a removable torsion brace of braces may be used rather than permanent midline torsional brace 901.

Even in embodiments where upper torsional braces provide enough torsional rigidity when the rack is off-truck, preferred embodiments may employ one or more midline braces which link one side of the rack to the other such that the side-to-side spacing of the mounting rails 307 of the rack remain consistent off-truck and on-truck. To maintain such consistent spacing such braces are typically rigid, such that they can operate in compression or tension. Such braces may be removable, and shall in this document be referred to as midline torsional braces, even though their primary purpose is to maintain consistent spacing of the racks mounting and alignment points when the rack is off-truck.

In another aspect, a preferred embodiment of the present invention provides no-scratch guides 906 which keep the rack approximately centered (form side to side) over the pickup bed as the rack is lifted slightly (relative to its mounted height) and moved forward for installation or backward for removal. In a preferred embodiment, these guides function over at least several vertical inches of elevation of the rack above final mounted height. The guides automatically pivot to pass over the edges of the tailgate frame during removal and installation.

In another aspect, the present invention provides lower front torsion braces 701 and lower rear torsion braces 603 which are quickly and easily detachable, and which have anti-theft features to prevent unauthorized detachment. In another aspect, a preferred embodiment of the present invention includes detachable rolling jacks 1001, which allow one person to quickly and easily install or remove the rack without assistance.

In another aspect, a preferred embodiment of the present invention incorporates forward travel stop 904, which prevents the rack from sliding too far forward on the truck bed during installation, and aids in alignment during the installation process. A preferred embodiment also includes beveled alignment nubs attached to the lower side of rack rails 308 which sit on the pickup truck bed rails. These beveled alignment nubs are positioned to align with stake holes provided in typical pickup truck bed rails. In an alternate embodiment, the present invention includes hardware mountable in pickup truck bed wall stake holes, which includes a captive metal loop which may be raised through a slot in the rack and locked in place with a padlock, deterring rack theft and securing the rack against slippage during hard braking of a pickup truck carrying a heavily loaded rack. In an alternate preferred embodiment, the rack is attached to hardware mounted in truck bed wall stake holes.

In another aspect, in a preferred embodiment of the present invention, clamps 907 are used (rather than bolts) to attach the rack to the pickup bed rails. In a preferred embodiment, clamps are quick-adjustable to the right clamping span, provide high leverage for the final portion of tightening, and are self-centering under the rail lip of the pickup bed.

### BRIEF DESCRIPTION OF THE DRAWINGS

FIG. 1 is a photo of a typical large heavy-duty modern glass delivery truck.

FIG. 2 is a photo of a typical light-duty modern glass delivery truck with an aluminum glass rack.

FIG. 3 is a photo of a typical light-duty modern glass delivery truck with a steel glass rack.

FIG. 4 is a photo of a vertical brace used to transfer some of the vertical load of a glass-carrying rack around the bed wall to the bed to avoid mechanical distortion of the bed wall under peak load conditions.

FIG. 5 is a photo of a pickup-truck-mountable removable glass rack according to a preferred embodiment of the present invention.

FIG. 6 is a photo of a lower rear torsion brace according to a preferred embodiment of the present invention.

FIG. 7 is a photo of a lower front torsion brace according to a preferred embodiment of the present invention.

FIG. 8 if a photo looking forward through a pickup-mounted rack according to a preferred embodiment of the present invention.

FIG. 9 is a photo showing front and side automatic alignment mechanisms of a preferred embodiment of the present invention.

FIG. 10 is a photo of a removable socketed roller jack according to a preferred embodiment of the present invention.

FIG. 11 is a photo of wing bolts used in a preferred embodiment of the present invention.

FIG. 12 is a photo showing stake holes typically formed into the upper bed wall rails of modern pickup trucks.

FIG. 13 is a perspective view of a centering strip which can be adhesively applied to the bottom side of rack load bearing rails 911 to quickly and easily re-align the rack during re-installation in a preferred embodiment of the present invention.

FIG. 14 is a plan view of the centering strip of FIG. 13, with the non-stick adhesive-covering sheet partly peeled back.

FIG. 15 depicts a screw-attachable beveled alignment nub according to a preferred embodiment of the present invention.

FIG. 16 depicts an extendable lockable lower torsion brace according to a preferred embodiment of the present invention.

FIG. 17 is a photo of a compound-linkage quick-clamp that may be used to clamp a glass rack to a pickup truck bed wall rail according to a preferred embodiment of the present invention.

FIG. 18 is a photo of a pipe clamp that may be used to clamp a glass rack to a pickup truck bed wall rail according to a preferred embodiment of the present invention.

FIG. 19 is a photo of the same pipe clamp as FIG. 18, where the jaws have been rotated close to 180 degrees from one another as would be done to allow removal of the glass rack in a preferred embodiment of the present invention.

FIG. 20 is a photo of a commercial stake-hole-mountable tie-down, mounted in a pickup truck bed rail stake hole.

FIG. 21 is a photo of a glass rack mounting rail secured against theft and unwanted sliding by being padlocked to a stake-hole-mounted tie-down hasp.

### DETAILED DESCRIPTIONS OF SOME PREFERRED EMBODIMENTS

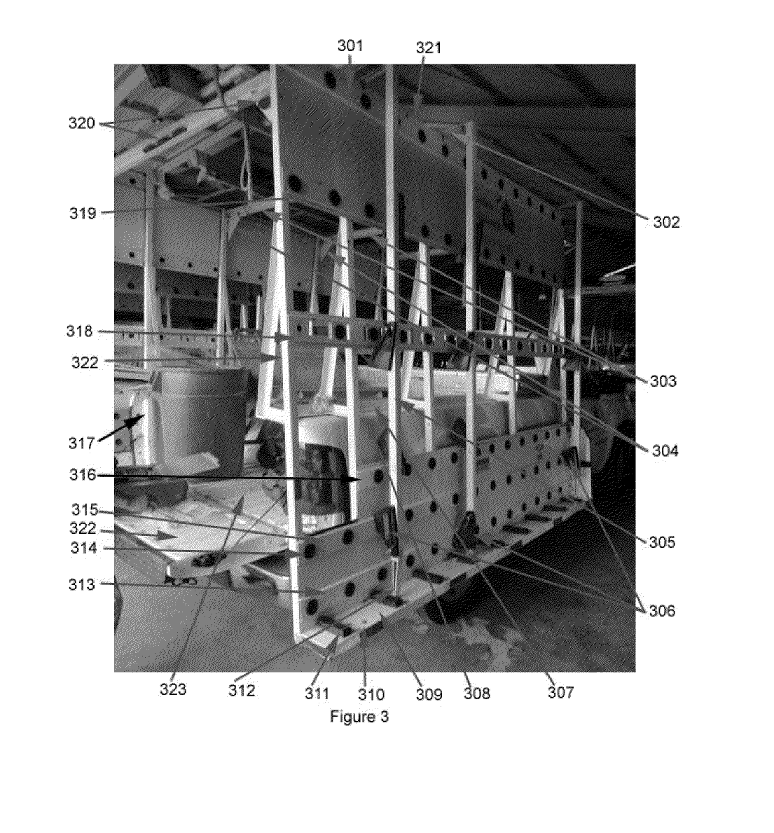

The term “glass rack” as used in this document shall be construed to mean a rack suitable for transporting glass or other sheet material, or stone slabs or the like. FIG. 3 is a photo of a typical modern light-duty glass delivery truck with a glass rack installed. Mounting rail 307 bolts to truck bed wall rail 308 and supports the weight of the glass rack on truck bed wall rail 308. The plane in which the interface between mounting rail 307 meets truck bed wall rail 308 shall be referred to in this document as the “primary plane of attachment”.

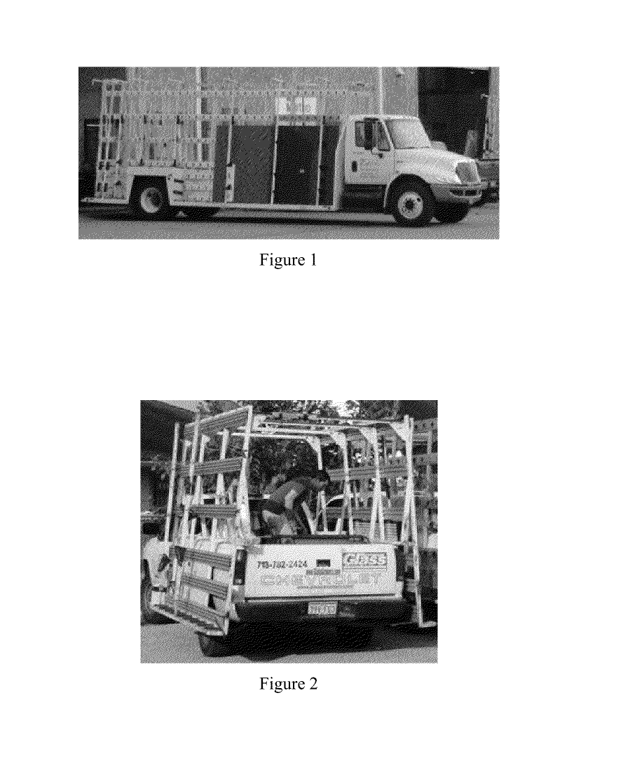

Glass or other sheet material which is loaded on the rack rests edge-wise on rubber pads 311 and the majority of the weight of the glass is transferred to lower support rail 309 through pads 311. A small fraction of the weight of glass or other sheet material loaded on the rack rests on surface pads 314 (also sometimes called “buttons”), which are mounted along first (lower) face rail 313, second face rail 315, third face rail 316, fourth face rail 318, fifth face rail 319, and 6^{th} (top) face rail 301. All face rails are mounted to vertical frame members 322. Face rails are also referred to in the industry as slats. Typically, lower support rail 309 is provided with stake holes 310 into which the lower pointed end 312 of stakes 305 fit. Rubberized clamps 306 (also sometimes called cleats) which attach to stakes 305 may be adjusted to push glass or other sheet material being transported against surface pads 314 (which may be round as in FIG. 3 or strip-shaped as in FIG. 2), which are typically also rubberized. Upper stake brackets 302 may be affixed to stakes 305 and removably engageable with the top surface 321 of upper face rail 301, or upper stake brackets 302 may be attached to upper face rail 301, and removably engaged with the upper end of stakes 305. Different manufacturers of pickup-truck-mountable glass racks may use different numbers of face rails, depending on the height and style of their racks.

While mounting the rack to truck bed sidewall rails 308 provides load bearing support, and torsional support around all axes perpendicular to the direction of travel of the truck, additional torsional bracing such as corner braces 304, combined with upper torsion braces 303 are typically needed to give the rack torsional stability around an axis parallel with the direction of travel of the truck. Equivalently, some racks accomplish such torsional bracing by bolting braces between lower support rail 309 and fixed mounting points underneath the truck toward the front and rear of the rack. Some racks may also be equipped with reflectors and/or lighting 320 to enhance visibility and safety on the road.

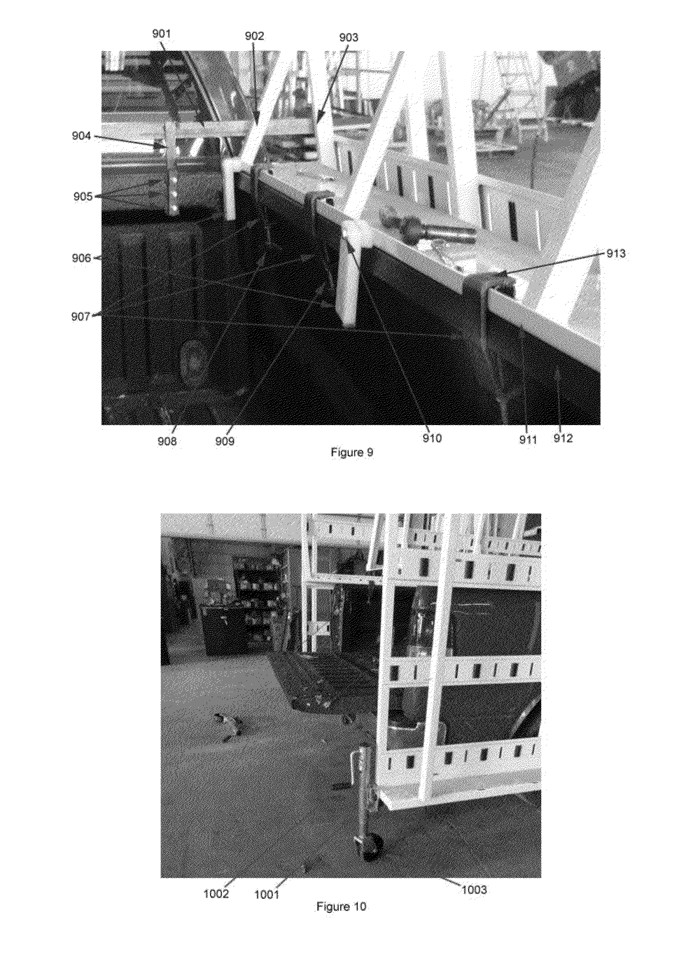

FIG. 9 is a photo showing portions of pickup-truck-mountable rack according to a preferred embodiment of the present invention. In a preferred embodiment, lower torsion brace 901 traverses the rack just behind the cab of the pickup truck, and preferably attaches at at least two places 902 and 903 on each side, either by welding or bolting. When the rack is mounted to the truck, it is secured by clamps 907, which clamp mounting rail 911 to truck bed wall rail 912. In a preferred embodiment, clamps 907 each include butterfly handle 908, or a hexagonal head, which is used to turn threaded rod 909 to tighten or loosen the clamp. Upper clamp end 913 hooks over mounting rail 911, and in a preferred embodiment, the upper end of threaded rod 909 terminates in a centering block or winged leaf spring which keeps the upper end of threaded rod 909 centered from side to side in the underside channel of truck bed wall rail 912. In such preferred embodiment, even when clamps 907 have been loosened enough so that the glass rack may be slid forward and backward on the truck bed rails, clamps 907 cannot be moved in any direction perpendicular to such forward and backward movement.

In a preferred embodiment, during mounting and dismounting, clamps 907 are not in place and mounting rail 911 is raised one or two inches with respect to truck bed wall rail 912. Mounting is preferably accomplished by moving the rack forward from a position behind the truck to a position slightly elevated from the mounted position, and then lowering the rack onto the truck and securing the rack. Similarly, dismounting is preferentially accomplished by unclamping mounting rail 911, and then raising the rack slightly and moving it rearward off the truck. Mounting and dismounting is preferably done with the tailgate in the open (folded down) position, to allow forward travel stops 904 to pass through the tailgate opening.

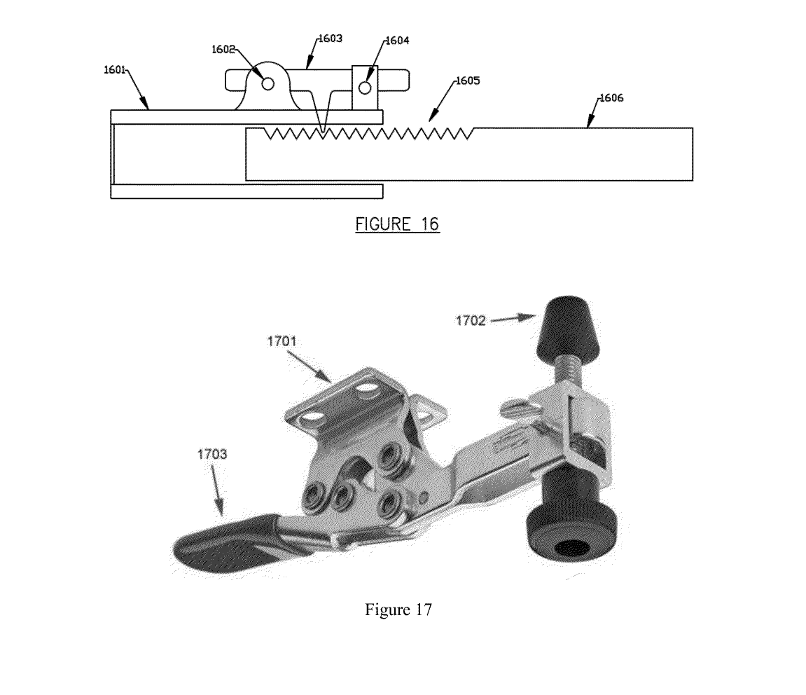

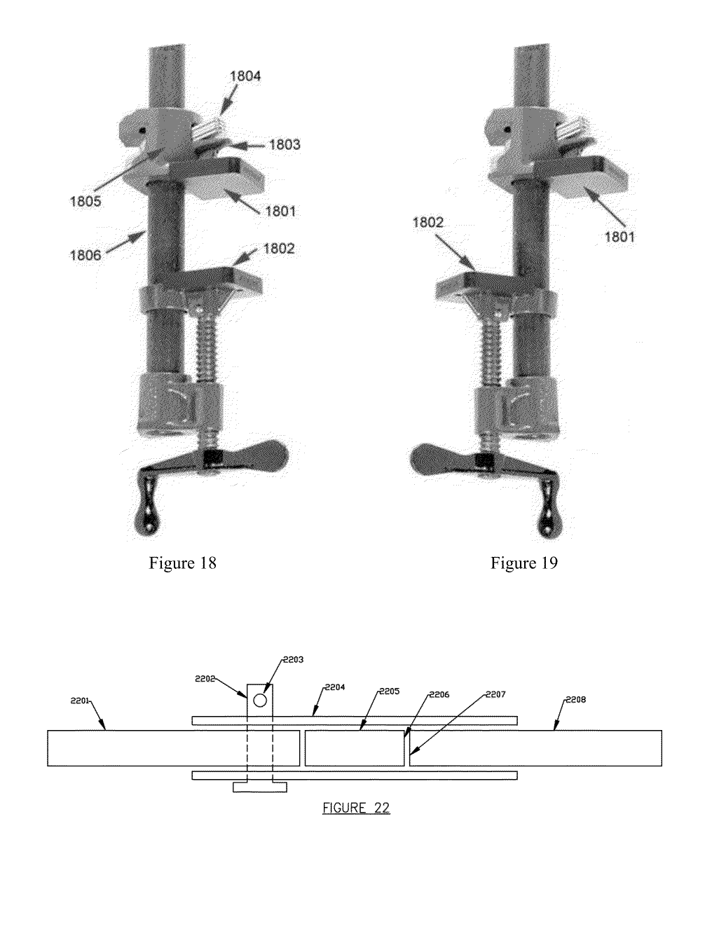

Alternate preferred embodiments incorporate clamps that are at one end permanently affixed to rack attachment rail 911, and where the portion of the clamp which engages the underside of truck bed wall rail 912 swings out of the way while the rack is being moved onto or off of the truck. FIGS. 17, 18, and 19 are photos of such clamps. FIG. 18 is a photo of a pipe clamp. Face 1801 of this clamp may be affixed to rail 911. Quick-adjustment engagement plates 1804 may be pinched manually against stop 1803, allowing pipe 1806 to rapidly be slid through adjustment housing 1805. The clamp may then be tightened by turning handle, pushing clamp face 1802 into the underside of truck bed wall rail 912. While the rack is being slid on an off the truck, pipe 1806 may be rotated within adjustment housing 1805 to allow the rack to be slid off the rear of the truck without the clamp handle and clamp face 1802 interfering with truck tailgate stop 317.

In a preferred embodiment, while moving the rack forward and backward during mounting and dismounting (respectively), sideways centering guides 906 keep the rack centered from side over the truck bed. In a preferred embodiment, centering guides 906 hang vertically down into the truck bed a few inches to accomplish their centering function even when the rack is lifted a couple of inches with respect to the bed wall rails, so that their centering function is not compromised by slightly elevating the rack with respect to the truck. Likewise, in a preferred embodiment, forward stop guides 904 stick down at least a couple of inches past the bed wall rail when the rack is mounted, to allow them to function properly when the rack is slightly lifted during installation and removal.

In a preferred embodiment, clamps such as shown in FIG. 17 are attached at face 1701 to extensions of attachment rail 911 which extend toward the center of the truck bed a few inches. Swinging clamp handle 1703 up into the position shown in FIG. 17 moves clamp nose 1702 up under the underside of truck bed wall rail 912, and clamps the rack in place. In a preferred embodiment, a slot is provided in handle 1703, through which a padlockable loop fits when the clamp is in the clamped position shown. In such a preferred embodiment, each clamp may be padlocked in the clamped position.

In a preferred embodiment, removable jacks 1001 (shown in FIG. 10) enable a single person to jack up the rack an inch or so by sequentially turning jack handles 1002 on all four jacks to raise the rack after the clamps are un-clamped. The rack can then be rolled off the truck in a rearward direction by one person, on rollers 1003. Likewise, during installation, the rack may be rolled in place by one person, and lowered onto the truck, and attached in a matter of minutes by one person.

In a preferred embodiment, centering guides 906 are made of or coated with a low-friction material which will not leave scratches if rubbed against paint. Likewise, in a preferred embodiment, forward stops 904 include bumper material 905 which is soft enough that it will not cause damage when bumped against a painted surface. In an alternate embodiment, the surface of centering guides 906 comprise rollers with their axis of rotation normally vertically aligned. In a preferred embodiment, centering guides 906 are able to pivot from front to back around pivot points 910 so that they can automatically clear tailgate side stops 317 (see FIG. 3) during installation and removal of the rack.

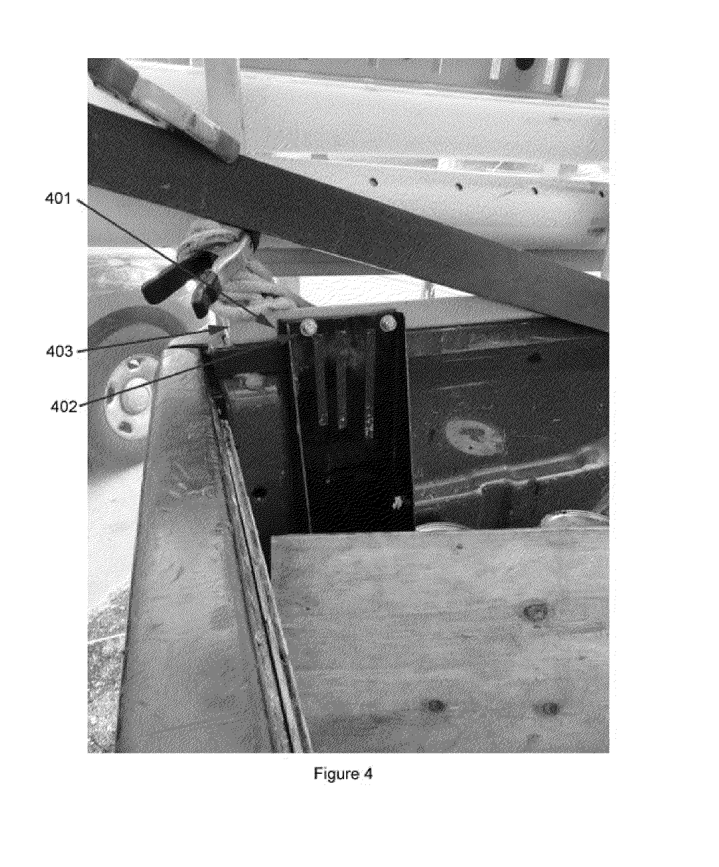

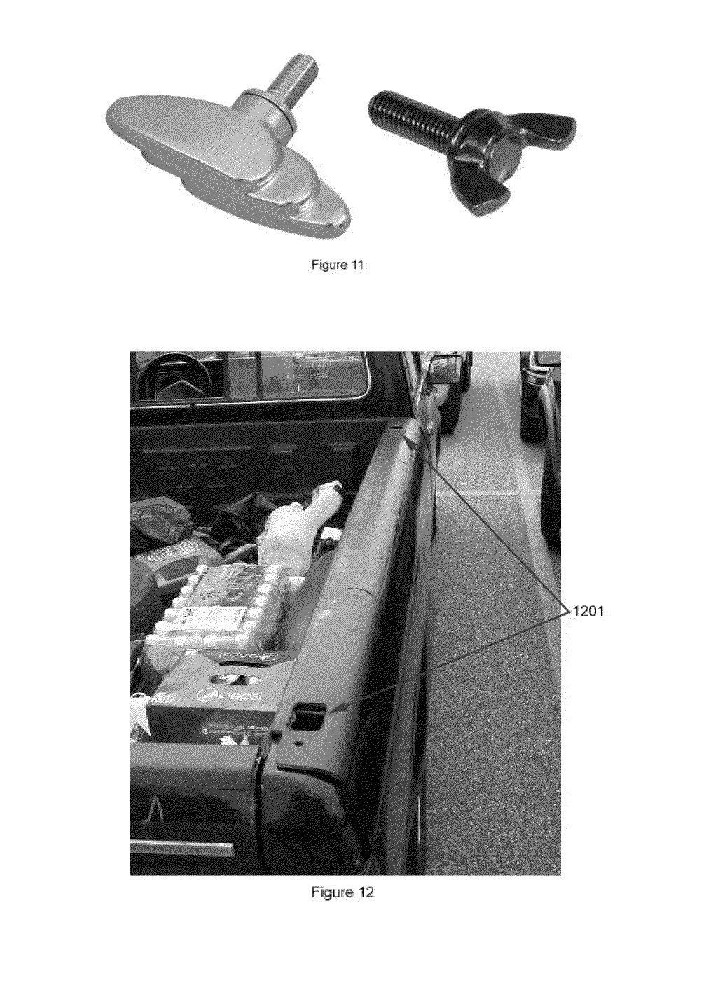

FIG. 4 is a photo of a typical load-bearing brace 401 which transfers some of the vertical load of glass rack 403 to the bed of the pickup truck so that not all of the vertical load of glass rack 403 needs to be supported by pickup truck bed walls 404. As is typical in the art, the portion of the vertical load of rack 403 which is transferred to brace 401 is transferred through bolts 402. A preferred embodiment of the present invention includes a vertical brace similar to brace 401, which attaches with wing bolts such as shown in FIG. 11.

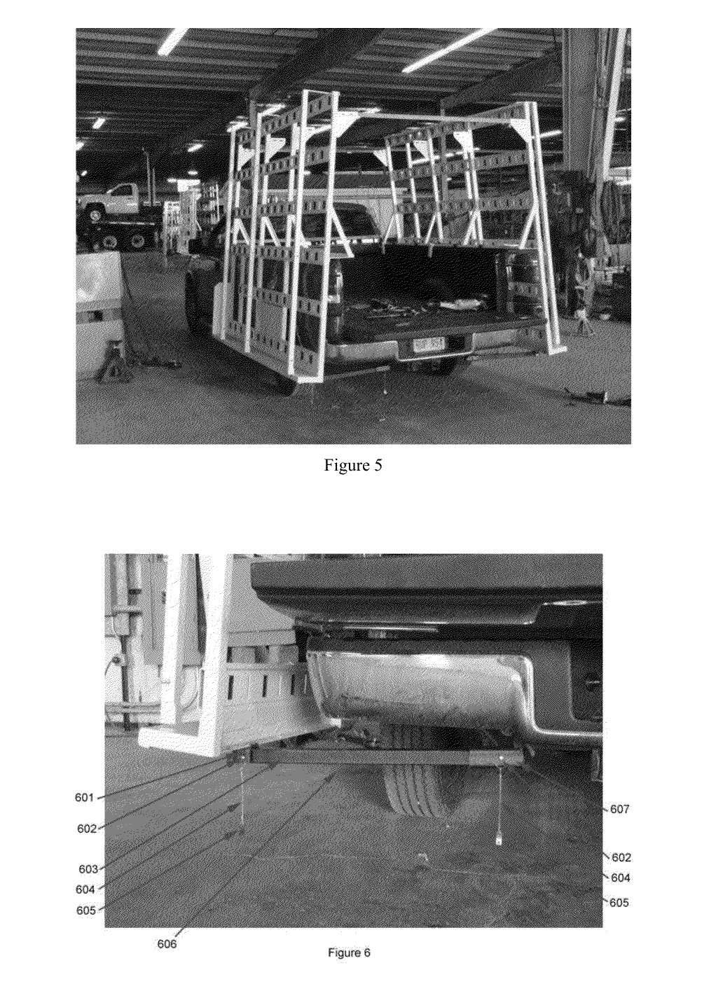

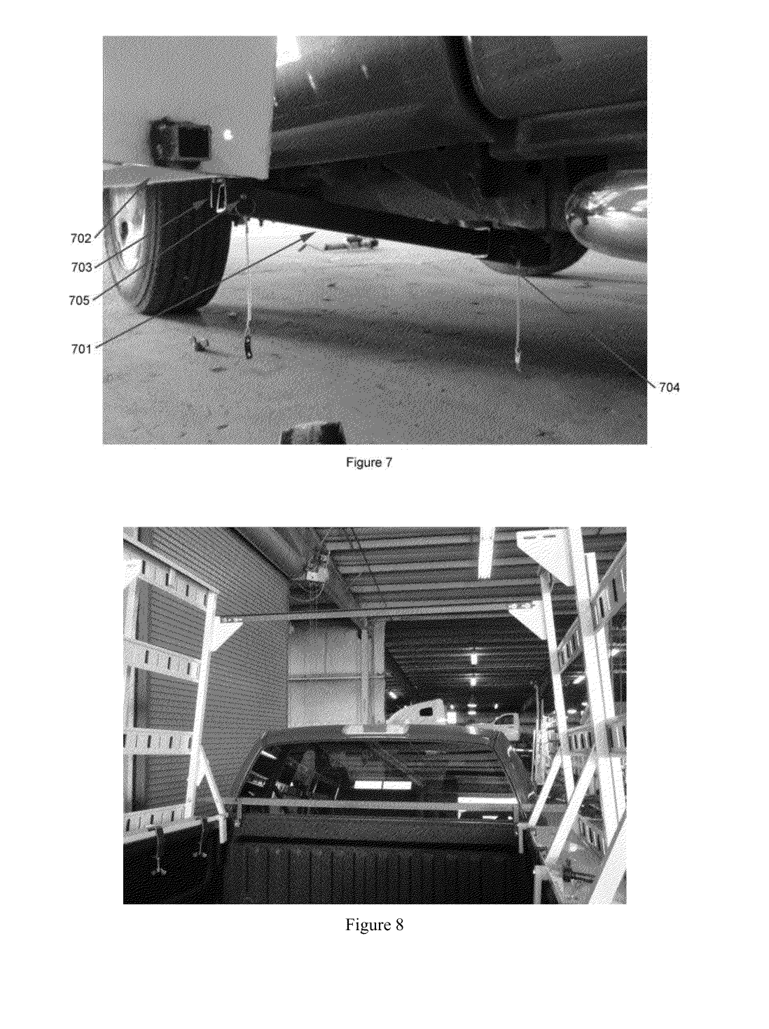

In a preferred embodiment, the upper left and right sides of the rack are joined by upper braces 303, which may also include extra upper torsional reinforcements 304. Additionally, in a preferred embodiment, removable lower torsional braces 606 & 701 (see FIGS. 6 & 7) attach all four lower corners of the rack to the truck. In a preferred embodiment, all four lower torsion braces are formed similarly, though front lower torsion braces (shown in FIG. 7) and rear lower torsion braces (shown in FIG. 6) may be different lengths. In a preferred embodiment, each lower torsion brace comprises a rack-attaching end 601, a truck-attaching end 607, and a brace bar 603 which latchably attaches to truck-attaching end 607 and rack-attaching end 601. In a preferred embodiment, truck-attaching end 704 surrounds brace bar 701 on at least 4 sides in the assembled state, whereas rack-attaching end 703 surrounds brace bar 701 on only 3 sides, allowing rack-attaching end 703 to be disengaged from bar 701 by lifting rack 702 after disengaging pin 705.

Within this document, the term “latchably attachable” shall be construed to include any means of attachment that will not self-detach under vibration conditions such as are typical in a vehicle traveling on the road, and which can be detached by hand without the use of tools. Using the language of physics, latchable attachment methods all represent in the latched state a system sitting in a potential energy well. Getting out of the potential energy well requires putting in enough energy to overcome the well. In frictional latchable attachment methods (such as hand-tightenable wing bolts, or twist cams as are used on quick-release bicycle hubs, or adjustable tripod legs), the potential well is provided by the difference between the (higher) coefficient of static friction and the (lower) coefficient of dynamic friction between two surfaces. In door latches, the potential well is provided by the energy needed to compress a spring enough to remove a catch from a hole. In locking pliers, the potential well is provided by moving a linkage slightly past its maximum compression point, into a less compressed position that rests against a stop. In modern trailer hitches, latching is typically accomplished by sliding a curved spring clip in a slot, to a position where the clip is spread less than it is at positions on either side of that position. Within this document, the term “clampably attachable” shall be construed to include any means of attachment that does not require drilling holes in the truck bed, bed walls, or bed wall rails.

In the lower torsional brace embodiment shown in FIG. 6, the brace 606 is assembled by sliding brace bar 603 through rack-mounting end 601 and into truck-mounting end 607, and passing spring-latched pins 602 through ends 601 and 607. When the lower torsion brace shown in FIG. 6 is removed, accidental loss of pins 602 is prevented by attachment cables 604 which fasten to ends 601 and 607 via attachments 605. To provide lockable installation of bar 603, pins 602 may formed as the shackle of a padlock which returns around the underside of attachments 601 and 607. A variety of alternate equivalent means of locking are possible.

In a preferred embodiment attachment end 601 is bolted to, welded to, or formed in lower rack rail 310. In a preferred embodiment, attachment end 607 is formed in, welded to, or bolted to the pickup truck body, frame, bumper, or trailer attachment mechanism. In a preferred embodiment, in the attached position, bar 603 is captive (in the un-latched state) in either truck attachment end 607 or rack attachment end 601 over a sufficient length that locking the opposite end effectively prevents removal of bar 603 without removing one of either attachment 601 or 607, or damaging the rack in some way. Thus in a preferred embodiment, only one locking mechanism is required to lock a lower torsion brace in place to deter theft or tampering.

Since all lower torsion braces are normally in compression when the rack is carrying a load, in an alternate preferred embodiment rack attachment end 601 and truck attachment end 607 may effectively be formed as hollow sockets, and latching in place of bar 602 may be accomplished by making bar 602 latchably extendable. FIG. 16 depicts a cutaway view of an extendable lockable lower torsion brace according to a preferred embodiment of the present invention. Bar 1606 slides inside hollow bar 1601. Latching mechanism 1603 pivots around pivot pin 1602 and in the latched position engages one of a plurality of serrations 1605 formed on bar 1606. When latching mechanism 1603 is disengaged, bar 1606 can slide freely in hollow tube 1601. When a pin or padlock shackle is placed through hole 1604, latching mechanism 1603 is held engaged with serrations 1605, and bar 1606 can no longer slide with respect to tube 1601.

In a preferred embodiment, the edge angles of serrations 1605 and the engaging part of latching mechanism 1603 may be asymmetrically formed in a matched way to form a ratcheting mechanism, and latching mechanism 1603 may be spring-loaded to facilitate ratcheting. In such an embodiment, prior to torsion brace installation, latching mechanism 1603 may manually be held in the disengaged position and bar 1606 may be slid all the way into tube 1601. To install the torsion brace, the user then just manually ratchets out bar 1606 with respect to tube 1601, thus lengthening the bar until one end engages truck-mounted attachment 607 and rack-mounted attachment 601, which in such case include hollow socket portions into which the bar ends can extend. In such an embodiment, once a lock is placed through lock hole 1604, the length of the torsion brace cannot be shortened, so it cannot be removed from either socketed end. In such an embodiment, if serrations 1605 are made fine enough, the torsion brace may be expanded into place in such a way that it is constantly held in compression and thus does not rattle in transit. In an alternate embodiment, serrations may not be used, and lever 1603 may be formed as a high-leverage lockable cam to clamp down on the surface of bar 1605 and hold it firmly in place.

FIG. 22 shows an adjustable length torsion brace to be used in compression similarly to the brace shown in FIG. 16, but instead of the length adjustment being accomplished one serration at a time, various spacers 2205 are provided to accomplish various lengths, or a single spacer 2205 may be composed of two parts which thread together such that the length of the spacer depends on how far the two parts are threaded together, or spacer 2205 may be a bolt which threads into the end of rod 2201 or rod 2208. To assemble the brace shown in FIG. 22, pin 2202 is removed, and sleeve 2204 is slid back, exposing all of bar 2208 and part or all of spacer 2205. Spacer 2205 may be replaced or adjusted to alter the length of the brace.

During assembly, sleeve 2204 is slid back as described above, and spacer 2205 is inserted and/or adjusted. Then the outer ends of bars 2208 and 2201 are inserted into sockets affixed to or formed into the rack and the truck frame or body, respectively. Next, face 2206 of spacer 2205 is aligned with face 2207 of bar 2208, and sleeve 2204 is slid into the position shown in FIG. 22. Next, pin 2203 is inserted, fastening bar 2201 to sleeve 2204, and a padlock hasp may be inserted through hole 2203 to lock the brace in the assembled configuration. Note that in the assembled configuration, bars 2201 and 2208 are held in compression between the rack and the truck, and since sleeve 2204 covers spacer 2205 completely, the assembled brace cannot be disassembled without removing pin 2202.

In an alternate embodiment, the torsion brace of FIG. 22 may be made with just two bar pieces and a sleeve (for instance, where spacer 2205 is part of bar 2208, and different length bars 2208 may be interchanged to provide different assembled lengths. In a preferred embodiment, a second pin similar to pin 2202 may be provided through sleeve 2204, and a plurality of holes through bar 2208 may allow this pin to pass through at different points, making the overall length of the brace adjustable by choosing which hole in bar 2208 to place the second pin through. In an alternate preferred embodiment, several holes through sleeve 2204 can be spaced apart by a one distance, such that each can align with one of a set of holes through bar 2208 (spaced apart by a different distance) such that finer adjustments of overall length are obtainable by choosing an alignment combination between one of the holes through sleeve 2205 and one of the holes through bar 2208. Any second pin may be made lockable as pin 2202 (shown). Either pin in any of these embodiments may be inherently be lockable if the shackle of a padlock is used as the pin.

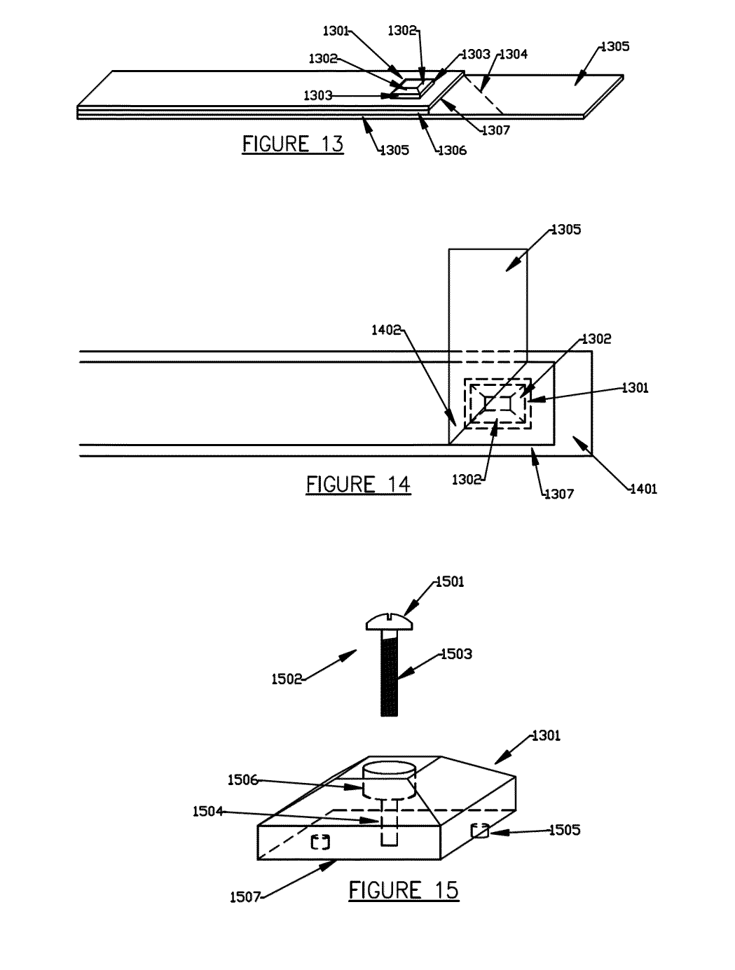

FIG. 12 is a photo showing truck stake holes 1201 typically formed into the upper bed wall rails of modern pickup trucks. In a preferred embodiment of the present invention rack mounting rails 911 include attached beveled alignment nubs 1301 (see FIGS. 13-15) underneath to automatically align the rack properly on the pickup truck as the rack is lowered from an approximately aligned position. In one preferred embodiment, alignment nubs 1301 are pre-attached to the underside of mounting rails 911 during rack manufacture. In an alternate preferred embodiment, the positioning of beveled alignment nubs 1301 (one for each truck stake hole) is done after rack purchase by the rack user, allowing the rack to be customized to fit the pickup truck of the user.

In one customizable preferred embodiment, beveled alignment nubs 1301 are formed as part of a plastic strip 1307, which is supplied with alignment nub 1301 on one side and adhesive 1306 on the other side, where the adhesive is covered with a protective non-stick peelable sheet 1305. In this preferred embodiment, prior to placing the rack on the truck for the first time, alignment nubs 1301 are placed with beveled surfaces 1302 and alignment surfaces 1303 inside truck stake holes 1201, and peelable sheet 1305 is folded along line 1304. Then the rack is placed on the truck and aligned, and a tension force F as shown in FIG. 14 is applied to peelable sheet 1305, peeling back the peelable sheet (for instance by propagating fold line 1304 to position 1402 and beyond), exposing adhesive and allowing plastic strip 1307 to stick to the underside of rack load bearing rail 911. The rack is then lifted slightly from the truck, and upward pressure is applied to plastic strips 1307, firmly adhering strips 1307 and alignment nubs 1301 to the underside of rack attachment rails 911. In a preferred embodiment, upper torsion braces 303 may be slidably coupled in a similar way. Since such upper braces do not need to be disassembled when the rack is removed, they may be more simply slidably clamped at the desired length by bolts.

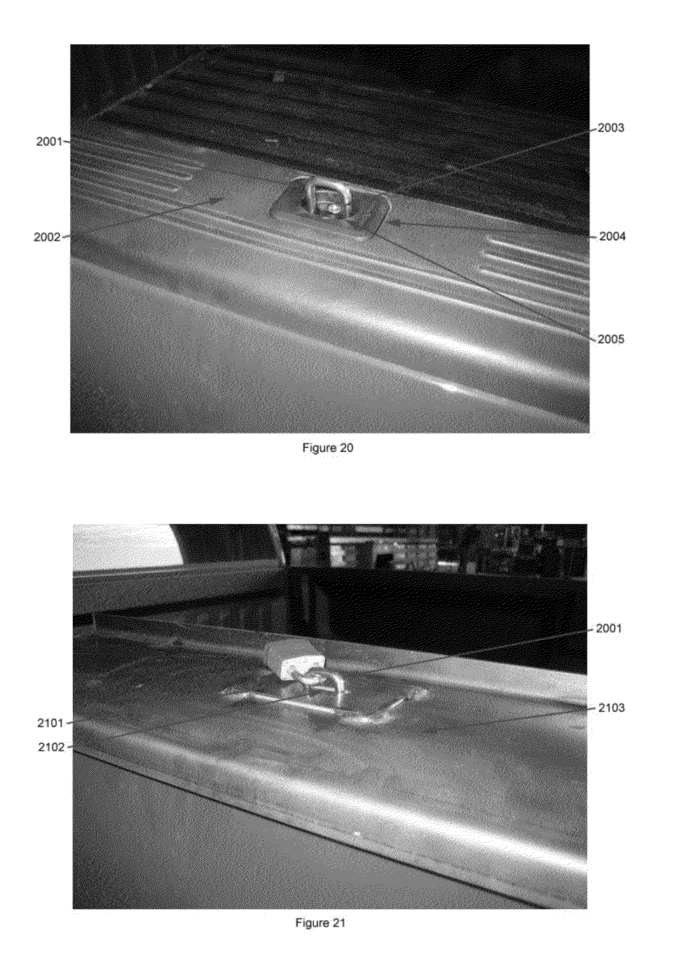

As an anti-theft measure and a safety measure against the rack sliding forward during hard braking into the cab of the truck if the rack is not properly clamped down, a preferred embodiment both aligns the position of the rack using the truck bed rail stake holes, and locks the rack down to the truck bed walls using hardware mounted in the truck bed wall stake holes. FIG. 20 shows a commercially available tie-down 2004 mounted in a pickup truck bed wall stake hole. Screws 2003 clamp upper and lower portions of the assembly above and below steel of the truck bed wall rail 2002. Extendable hasp 2001 (shown raised in FIG. 20) may be manually lowered into recess 2005 when not in use. In a preferred embodiment of the present invention, hasps which cannot be lowered into a recess are used. In a preferred embodiment, lockable attachments are mounted in two stake holes of the truck bed wall rails (for lockably coupling the rack to the truck), and beveled alignment nubs are mounted to the underside rack support rail 309 to automatically align the rack as it is lowered into place from a position of approximate alignment.

FIG. 21 is a photo of a rack mounting rail 2103 (analogous to rack mounting rail 307 in FIG. 3) with a slot 2102 cut through the rail. When the rack is properly aligned on the truck, hasp 2001 extends through slot 2102 so that the rack can be padlocked in place by passing padlock shackle 2101 through hasp 2001, preventing the rack from sliding forward or backward on truck bed rail 2002, and making theft of the rack more difficult.

In an alternate preferred embodiment shown in FIG. 15, alignment nubs 1301 may be attachable to rack attachment rail 911 by screws 1501, which pass through clearance holes in nubs 1301, where each clearance hole may be a single-diameter hole 1504, or may additionally provide screw-head-recess hole 1506. Additionally, in some embodiments, rotation of alignment nub 1301 is restricted once the nub is attached, either by virtue of the nub being attached by multiple screws, or by anti-twist nubs 1505 sticking into holes in rail 911, or by adhesive applied to attachment surface 1507.

The foregoing discussion should be understood as illustrative and should not be considered to be limiting in any sense. While this invention has been particularly shown and described with references to preferred embodiments thereof, it will be understood by those skilled in the art that various changes in form and details may be made therein without departing from the spirit and scope of the invention as defined by the claims.

What is claimed is:

1. A lower torsional brace for a pickup-truck-mountable glass rack, comprising:
truck coupling means formed in or affixed to a pickup truck body or frame;
rack coupling means affixed to or formed in the lower half of a pickup-truck-mountable glass rack; and
linking means comprising a truck end and a rack end, said truck end latchably attachable to said truck coupling means and said rack end latchably attachable to said rack coupling means.

2. The lower torsional brace of claim 1, further comprising:
anti-rattle means for holding in compression the portion of the surface of said truck coupling means and the portion of the surface of said truck coupling end which contact each other; and
anti-rattle means for holding in compression the portion of the surface of said rack coupling means and the portion of the surface of said rack coupling end which contact each other.

3. The lower torsional brace of claim 2, further comprising a locking means, lockable to prevent the disengagement of at least one of said rack coupling end or said truck coupling end from said rack coupling means or said truck coupling means, respectively.

4. The lower torsional brace of claim 3, further comprising a locking means, lockable to prevent the disengagement of at least one of said rack coupling end or said truck coupling end from said rack coupling means or said truck coupling means, respectively.

5. A glass rack latchably or clampably attachable to a pickup truck, said truck including bed walls top rails which may or may not include stake holes, said rack comprising:
mounting rails which transfer some of the weight of said rack to the top surface of the pickup truck bed walls;
material supporting means for carrying material on the exterior side of said pickup truck bed walls; and
means for latchably or clampably attaching said rack to said pickup truck bed wall rails.

6. The glass rack of claim 5, further comprising alignment nubs attached to the underside of said mounting rails, said alignment nubs positioned to protrude into said stake holes while said rack is mounted on said truck.

7. The glass rack of claim 5, further comprising lower torsion braces latchably attachable to said rack and said truck.

8. The glass rack of claim 5, further comprising at least three jacks affixed at different points on said rack, and operable to transfer the weight of said rack to the ground and lift said rack sufficiently so that said rack can be rearwardly removed from said truck.

9. The glass rack of claim 8, wherein said jacks are removable from said rack by hand.

10. The glass rack of claim 8, wherein said jacks comprise wheels which allow said rack to be rolled off said truck.

11. The glass rack of claim 8, wherein said jacks comprise rolling casters which allow said rack to be rolled off said truck.

12. The glass rack of claim 5, further comprising:
a plurality of vertical frame members on each side of said rack;
a plurality of upper torsional braces affixed directly or indirectly to the tops of said vertical frame members; and
a midline torsional brace at the forward end of said rack, affixed directly or indirectly to the forward-most vertical frame members on each side of said rack, said midline torsional brace being at least 6 inches below said upper torsional braces, and above the floor of the pickup bed when said rack is mounted on said truck.

13. The glass rack of claim 12, wherein said midline torsional brace attaches at more than one point on each side of said rack.

14. The glass rack of claim 5, further comprising alignment guide means extending below the primary plane of attachment of said rack, between the bed walls of said truck, when said rack is mounted to said truck.

15. The glass rack of claim 14, wherein said guide means can pivot forward and backward when a forward or backward force is applied to said guiding means below the primary plane of attachment of said rack, and said guiding means can pivot to a position where said guiding means extend less far below the primary plane of attachment of said rack.

16. The glass rack of claim 5, further comprising a midline torsional brace attachable for use during installation and removal of said rack.

17. The glass rack of claim 5, further comprising a forward travel stop affixed to said rack such that said stop extends below the primary plane of attachment of said rack in a position between the bed walls of said truck and within one inch of the front bed wall of said truck when said rack is mounted on said truck.

18. The glass rack of claim 17, wherein said forward travel stop further comprises bumper material affixed to the forward end of said forward travel stop, said bumper material being softer than typical automotive paint.

19. The glass rack of claim 5 further comprising locking means for locking said rack to said pickup truck.

20. The glass rack of claim 16, wherein said locking means comprise hasp means mounted in truck bed wall stake holes.

21. The glass rack of claim 5, further comprising hardware which remains mounted in truck bed wall stake holes whether said rack is mounted on said truck or not, said stake hole hardware lockable to said mounting rails when said rack is installed on said truck.

22. The glass rack of claim 5, further comprising alignment nubs attached to the underside of said mounting rails, said alignment nubs positioned to protrude into said stake holes while said rack is mounted on said truck.

23. The glass rack of claim 22, wherein each said alignment nub may be attached at a plurality of positions on the underside of said mounting rails.

24. The glass rack of claim 5, wherein said latchable attachment comprises clamps for clampably attaching said mounting rails to said bed wall rails.

25. The glass rack of claim 24, wherein said clamps are removable, and wherein said clamps engage with said mounting rails and said bed wall rail such that said clamps may not be removed when slightly loose.

26. The glass rack of claim 24, wherein said truck further comprises a tailgate, and wherein said clamps are permanently affixed to said mounting rails, and wherein a portion of said clamps pivot such that the rack can be slid off the truck rearwardly after being slightly raised, without said clamps interfering, provided the tailgate of said truck is open.

27. The glass rack of claim 24, further comprising hardware mounted in said truck bed wall rail stake holes, such hardware lockable to said rack mounting rails.

28. The glass rack of claim 5, further comprising hardware which remains mounted in truck bed wall stake holes whether said rack is mounted on said truck or not, said stake hole hardware latchably or boltably attachable to said mounting rails when said rack is installed on said truck.
